(19) United States
(12) Patent Application Publication
(10) Pub. No.: US 2021/0116733 A1
(43) Pub. Date: Apr. 22, 2021

(54) DISPLAY PANEL, MANUFACTURING METHOD THEREOF, AND DISPLAY DEVICE

(71) Applicant: TCL China Star Optoelectronics Technology Co., Ltd., Shenzhen, Guangdong (CN)

(72) Inventor: Qingyong ZHU, Shenzhen, Guangdong (CN)

(21) Appl. No.: 16/619,077

(22) PCT Filed: Nov. 13, 2019
(86) PCT No.: PCT/CN2019/118125

§ 371 Date: Dec. 3, 2019

(30) Foreign Application Priority Data
Oct. 18, 2019 (CN) 201910991060.7

(51) Int. Cl. G02F 1/1345; G02F 1/1333

(52) U.S. Cl. CPC G02F 1/13452; G02F 1/133308

(57) ABSTRACT

A display panel, a manufacturing method thereof, and a display device, including: a first substrate having a first short side; a second substrate disposed opposite to the first substrate, the second substrate having a second short side being flush with the first short side; and a chip-on-film bonded to the first short side and the second short side; wherein the second short side of the second substrate forms a first angle α with a lower surface of the second substrate, and 1°<α<60°.

### FIELD OF INVENTION

The present invention relates to the field of display technology, and in particular, to a display panel, a manufacturing method thereof, and a display device.

### BACKGROUND OF INVENTION

Thin film transistor liquid crystal displays (TFT-LCDs) mostly adopt outer lead bonding (OLB) design, and the upper and lower glass substrates are staggered by a non-flush cutting way to expose TFT bonding lead connected to a driving integrated circuit (IC), which is used for inputting driving signal into the panel. The method of connecting the driving IC is to bond one end of the chip-on-film (COF) to the bonding lead of the TFT glass, and the other end of the COF is bonded to a printed circuit board (PCB). An anisotropic conductive film (ACF) is usually used as an adhesive between the components to achieve fixation and conduction.

The exposed bonding leads of the OLB region increase the width of the frame of the whole device, which affects the appearance. To solve this problem, a new type of side bonding technology has emerged in the industry. The technology cuts the upper and lower substrates flush, exposes a cross-section of the bonding lead by side grinding, prints a conductive film on the cross-section, and bonds the COF from the side. It is then adhered to the frame by side sealing to achieve an ultra-narrow bezel.

### TECHNICAL PROBLEM

The ultra-narrow bezel display technique has the following problems: the contact impedance is high, the appearance is poor, the adhesion is insufficient, and the panel is separated from the frame when performing shock test, resulting in abnormal quality.

### SUMMARY OF INVENTION

The present invention provides a display panel, a manufacturing method thereof, and a display device. A display panel of the invention adopts the oblique edge grinding method to increase a cross-sectional area of bonding lead, reduce the contact impedance of the side bonding, increase the space for filler coating, increase the coating amount of filler, avoid the filler overflowing, and also improve an adhesion of the frame to the substrate.

In order to solve the above problems, in a first aspect, the present application provides a display panel. The display panel includes: a first substrate having a first short side; a second substrate disposed opposite to the first substrate, the second substrate having a second short side flush with the first short side; and a chip-on-film bonded to the first short side and the second short side; wherein the second short side of the second substrate forms a first angle α with a lower surface of the second substrate, and 1°<α<60°.

According to some embodiments of the invention, the display panel further includes a bonding lead disposed on a surface of the first substrate adjacent to a side of the second substrate, the bonding lead extends to the first short side of the first substrate to form a lead cross-section.

According to some embodiments of the present invention, the display panel further includes a conductive film disposed between the lead cross-section and the chip-on-film.

According to some embodiments of the invention, the conductive film is made of at least one of metal powder nickel, gold, silver, and tin alloy.

According to some embodiments of the invention, the display panel further includes a frame disposed on a side of the first substrate and perpendicular to a lower surface of the first substrate.

According to some embodiments of the invention, the display panel further includes a frame disposed on a side of the first substrate, and the frame has an arc shape.

According to some embodiments of the invention, the display panel further includes the printed circuit board, and the printed circuit board is bonded to the chip-on-film.

According to some embodiments of the invention, the display panel further includes a backlight source fixed to the frame by screws.

The application also provides a method for manufacturing a display panel, including:
step 1, providing a first substrate, and disposing a bonding lead on a surface of the first substrate;
step 2, providing a second substrate, and bonding the first substrate to the second substrate;
step 3: performing oblique edge grinding process on same sides of the first substrate and the second substrate to form a first short side and a second short side exposing a cross-section of the bonding lead; and
step 4: providing a conductive film and a chip-on-film on the cross-section of the bonding lead to form the display panel.

According to some embodiments of the invention, the step 3 further includes: cutting same sides of the first substrate and the second substrate, and then grinding the sides using a grinding wheel to form an oblique edge.

According to some embodiments of the invention, an inclination angle of the grinding wheel with respect to the second substrate when grinding the sides is a first angle α, and 1°<α<60°.

The present application further provides a display device including the above display panel. The display device includes: a first substrate having a first short side; a second substrate disposed opposite to the first substrate, the second substrate having a second short side flush with the first short side; and a chip-on-film bonded to the first short side and the second short side; wherein the second short side of the second substrate forms a first angle a with a lower surface of the second substrate, and 1°<α<60°.

According to some embodiments of the invention, the display panel further includes a bonding lead disposed on a surface of the first substrate adjacent to a side of the second substrate, the bonding lead extends to the first short side of the first substrate to form a lead cross-section.

According to some embodiments of the invention, the display panel further includes a conductive film disposed between the lead cross-section and the chip-on-film.

According to some embodiments of the invention, the conductive film is made of at least one of metal powder nickel, gold, silver, and tin alloy.

According to some embodiments of the invention, the display panel further includes a frame disposed on a side of the first substrate and perpendicular to a lower surface of the first substrate.

According to some embodiments of the invention, the display panel further includes a frame disposed on a side of the first substrate, and the frame has an arc shape.

According to some embodiments of the invention, the display panel further includes the printed circuit board, and the printed circuit board is bonded with the chip-on-film.

According to some embodiments of the invention, the display panel further includes a backlight fixed to the frame by screws.

### BENEFICIAL EFFECT

The embodiment of the present invention adopts the oblique edge grinding method to increase the cross-sectional area of the bonding lead and reduce the contact impedance of the side bonding; increase the space for side filler coating, increase the dispensing amount of filler, and prevent the problem of filler overflowing caused by small space; increase the contact area of the filler to the glass substrate and enhance the adhesion; at the same time, the filler forms a projection to secure the glass substrate, so that the frame is more firmly bonded to the glass substrate.

### DESCRIPTION OF DRAWINGS

In order to more clearly illustrate the technical solutions in the embodiments of the present invention, the following figures described in the embodiments will be briefly introduced. It is obvious that the drawings described below are merely some embodiments of the present invention, and other drawings can also be obtained by a person of ordinary skill in the field based on these drawings without making any creative effort.

FIG. 1 is a schematic structural view of a display panel provided in the prior art.

FIG. 2 is a schematic structural view of a display panel in an embodiment of the present invention.

FIG. 3 is a schematic structural view of a display panel in another embodiment of the present invention.

FIG. 4 is a schematic structural view of a display panel in yet another embodiment of the present invention.

FIG. 5 is a schematic flow chart of a manufacturing method in an embodiment of the present invention.

FIG. 6 is a schematic view showing an oblique edge grinding process according to a manufacturing method in an embodiment of the present invention.

### REFERENCE NUMERALS

101, upper polarizer; 111, lower polarizer; 102, second substrate; 112, first substrate; 122, second short side; 132, first short side; 103, backlight source; 104, liquid crystal; 114, sealant; 105, bonding lead; 106/206, conductive film; 107/207, chip-on-film; 117, printed circuit board; 108/208, filler; 109/209, frame.

### DETAILED DESCRIPTION OF PREFERRED EMBODIMENTS

The technical solutions in the embodiments of the present invention are clearly and completely described in the following with reference to the accompanying drawings in the embodiments of the present invention. It is obvious that the described embodiments are only a part of the embodiments of the invention, and not all of the embodiments. All other embodiments obtained by a person skilled in the art based on the embodiments of the present invention without creative efforts are within the scope of the present invention.

In the description of the present invention, it is to be understood that the terms “center”, “longitudinal”, “transverse”, “length”, “width”, “thickness”, “upper”, “lower”, “front”, “back”, “left”, “right”, “vertical”, “horizontal”, “top”, “bottom”, “inside”, “outside”, etc. is based on the orientational or positional relationship shown in the drawings. It is merely for the convenience of describing the present invention and simplifying the description, instead of indicating or implying that the device or component referred to must have a particular orientation, constructed and operated in a particular orientation. Thus, it should not be construed as limiting the invention. Moreover, the terms “first” and “second” are used for descriptive purposes only and are not to be construed as indicating or implying relative importance or implicitly indicating the number of technical features indicated. Thus, features defining “first” or “second” may include one or more of the described features either explicitly or implicitly. In the description of the present invention, the meaning of “a plurality” is two or more unless specifically defined otherwise.

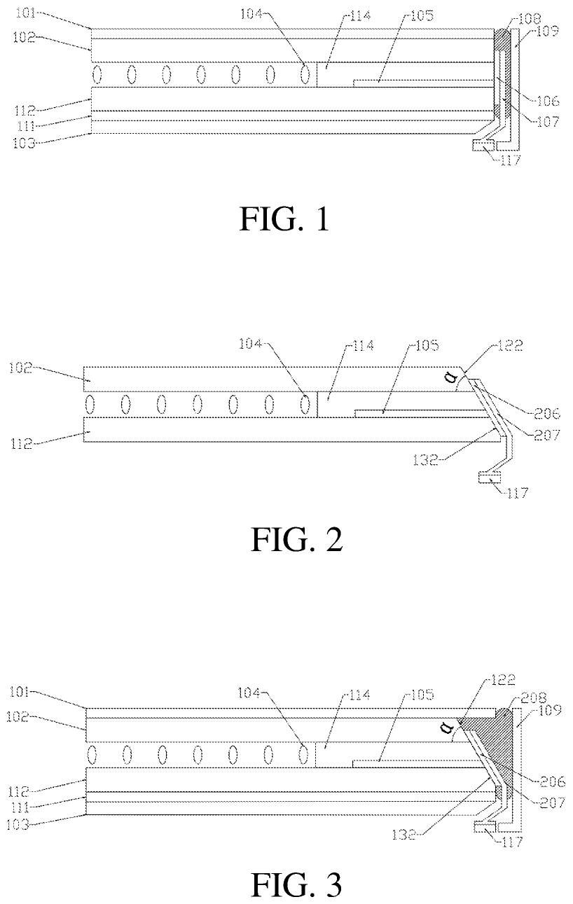

Shown in FIG. 1 is a schematic structural diagram of a display panel provided in the prior art. The display panel includes an upper polarizer 101, a lower polarizer 111, a second substrate 102, a first substrate 112, a second short side 122, a first short side 132, a backlight source 103, a liquid crystal 104, a sealant 114, and a bonding lead 105, a conductive film 106, a chip-on-film 107, a printed circuit board 117, a filler 108, and a frame 109. The display panel has the following problems: high contact impedance, poor appearance, insufficient adhesion, and separation of the panel from the frame during the shock test, resulting in abnormal quality.

Based on this, an embodiment of the present invention provides a display panel, a manufacturing method thereof, and a display device. The details are described below separately.

First, shown in FIG. 2 is a schematic structural diagram of an embodiment of a display panel according to an embodiment of the present invention. The display panel includes: a first substrate 112 having a first short side132; a second substrate 102 disposed opposite to the first substrate 112, the second substrate 102 having a second short side 132 flush with the first short side 122; and a chip-on-film 207 bonded to the first short side 132 and the second short side 122; wherein the second short side 122 of the second substrate 102 forms a first angle α with a lower surface of the second substrate 102, and 1°<α<60°.

In one embodiment, the first substrate 112 and the second substrate 102 are respectively a rectangular solid plate-like body having upper and lower surfaces and four sides. The first short side 132 and the second short side 122 are positioned between two long sides (not shown), and the first short side 132 and the second short side 122 are perpendicular to the two long sides, respectively. In this embodiment, the first short side 132 and the second short side 122 are preferably short sides adjacent to the chip-on-film; alternatively, the short side of one of the first substrate 112 and the second substrate 102 can be changed as needed.

In the embodiment of the present invention, the cross-sectional area of the bonding lead 105 is increased by making the second short side 122 of the second substrate 102 and the lower surface of the second substrate 102 at a specific angle, and thereby the contact impedance of the side bonding is reduced. Specifically, the space for the filler (side seal) 108 coating is increased, the coating amount of the filler is increased, and the problem of overflowing caused by small space is prevented. In other words, the contact area of the filler 108 and the glass substrate is increased, and the adhesion is enhanced. At the same time, the filler 108 forms a projection to secure the glass substrate, so that the frame 109 is more firmly bonded to the glass substrate.

The liquid crystal 104 and the sealant 114 are disposed between the first substrate 112 and the second substrate 102, and the liquid crystal 104 is positioned in a display area of the display panel. The sealant 114 is positioned in a non-display area of the display panel for bonding the first substrate 112 and the second substrate 102 to form the liquid crystal panel, and sealing an internal space of a liquid crystal cell, and preventing the liquid crystal 104 from overflowing. At the same time, water vapor and oxygen in the air are prevented from entering the liquid crystal cell. The curing methods of the sealant include a heat curing method, a photothermal curing method, and a photo-curing method. The bonding lead 105 is disposed on a surface of the first substrate 112 adjacent to the second substrate 102, the bonding lead 105 extends to a first short side 132 of the first substrate 112 to form a cross-section of the bonding lead, and the cross-section of the bonding lead also corresponds to a non-display area of the display panel. The conductive film 206 is disposed between the cross-section of the bonding lead and the chip-on-film 207. Since the first short side 132 of the first substrate 112 and the second short side 122 of the second substrate 102 are both inclined surfaces, a first angle a is formed between the second short side 122 of the second substrate 102 and a lower surface of the second substrate 102. Compared with the prior art, the cross-section of the bonding lead and the arrangement of the conductive film are changed, that is, an area of the cross-section of the bonding lead becomes larger, and an area that is in contact with the conductive film 206 also becomes larger, and the contact impedance of the side bonding is reduced.

Further, a first angle α is formed between the second short side 122 of the second substrate 102 and a lower surface of the second substrate 102, preferably 1°<α<60°, more preferably 3°<α<50°, and most preferably 5°<α<45°. One end of the chip-on-film 207 is bonded to a cross-section of bonding lead 105, and the other end of the chip-on-film 207 is bonded to the printed circuit board 117. The printed circuit board 117 is not limited in position and may be disposed on a side of the backlight source 103 away from the first substrate 112, or disposed on a side of the upper polarizer 101 away from the second substrate 102, which is advantageous to further reduce the width of the frame of the display panel, and thereby further realizing the narrow bezel design of the display device.

The conductive film 206 serves as an adhesive between the chip-on-film 207 and the cross-section of bonding lead, and an anisotropic conductive film (ACF) is generally used for achieving fixation and conduction of the bonding lead 105 and of the chip-on-film 207 and the chip-on-film 207 and the printed circuit board 117. ACF has the characteristics of continuous processing of extremely low material loss, mainly including resin adhesive and conductive particles. In addition to being used for moisture resistance, adhesion, heat resistance, and insulation, the resin adhesive is mainly used to fix the electrodes between the IC chip and the substrate, and providing a pressing force to maintain the contact area between the electrodes and the conductive particles. In terms of the conductive particles, the anisotropic conductivity mainly depends on the filling rate of the conductive particles and the particle size distribution, and the uniformity of the conductive particles also affects the anisotropic conductivity. Generally, the conductive particles must have good particle size uniformity and roundness to ensure that the contact area between the electrode and the conductive particles is uniform and maintain a stable on-resistance while preventing partial electrodes not touching the conductive particles from causing the issue of an open-circuit. The common particle size is ranging between 3 and 5 μm. Excessively large conductive particles will reduce the number of particles that each electrode touches, and will easily lead to short-circuiting of adjacent electrodes due to contact of conductive particles; however, if the conductive particles are too small, the problem of particle aggregation is likely to occur, resulting in uneven particle distribution density. In terms of the types of conductive particles, metal powders and polymer plastic spheres coated with metal are mainly used. The material of the conductive film 206 that is commonly used is at least one of metal powders of nickel, gold, silver, or tin alloys.

On the basis of the above embodiments, another embodiment of the present invention, as shown in FIG. 3, is a schematic structural diagram of a display panel in the present invention. The display panel further includes a frame 109 and a filler 108. The frame 109 is disposed on a side of the liquid crystal panel for fixing the liquid crystal panel. The liquid crystal panel and the frame 109 are bonded and fixed by the filler 108. Preferably, the frame 109 can be made of a metal material, and the filler 108 is a very high bond (VHB) filler. Specifically, the display panel further includes an upper polarizer 101, a lower polarized light 111, and a backlight source 103. The frame 109 is disposed on a side of the first substrate 112 and perpendicular to a lower surface of the first substrate 112. A threaded hole is disposed on a side of the frame 109 adjacent to the backlight source 103, and the backlight source 103 and the frame 109 are fixed by a screw. Compared to the prior art, a second short side 122 of the second substrate 102 forms a first angle a with a lower surface of the second substrate 102, which increases the coating space of the filler 108, increases the amount of filler applied, and prevents the problem of filler overflowing caused by small space. In other words, the contact area of the filler 108 with the glass substrate is increased, and the adhesion is enhanced; at the same time, the filler 108 forms a projection to secure the glass substrate, thereby the frame 109 is bonded to the glass substrate more firmly.

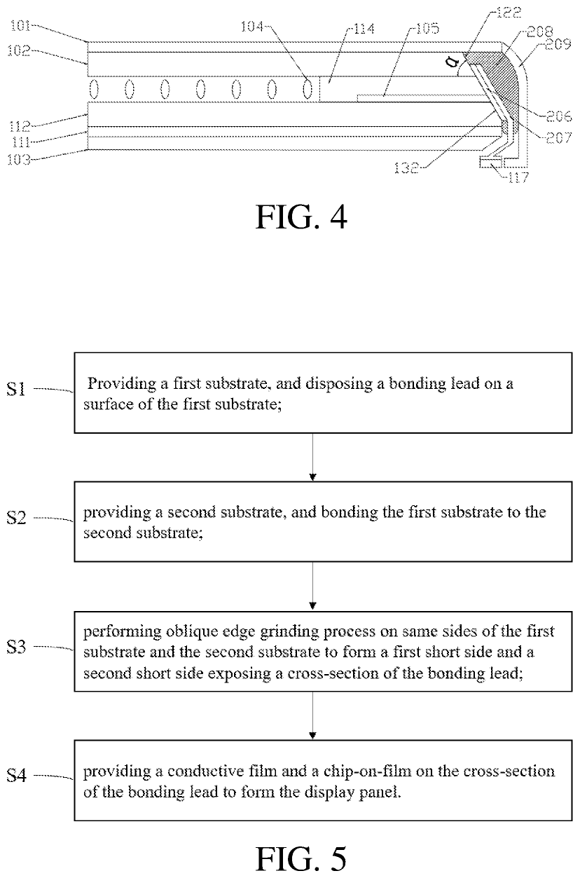

Of course, in the embodiment of the present invention, the frame 109 can be further optimized. Therefore, based on the above embodiment, in another embodiment of the present invention, shown in FIG. 4 is a schematic structural view of a display panel in the present invention. The frame 209 is disposed on a side of the first substrate 112, and the frame 209 is curved so that the shape of the filler 208 is also changed, which can further make the frame 209 and the liquid crystal panel combined more firmly.

In order to realize the structure of the display panel, the embodiment of the present invention further provides a method of manufacturing a display panel, as shown in FIG. 5, which is a schematic flowchart of the manufacturing method in the embodiment of the present invention.

The method of manufacturing the display panel includes the following steps:
step 1 (as S1 shown in the figure), providing a first substrate 112, and disposing a bonding lead 105 on a surface of the first substrate 112;
step 2 (as S2 shown in the figure), providing a second substrate 102, and bonding the first substrate 112 to the second substrate 102;
step 3 (as S3 shown in the figure), performing oblique edge grinding process on same sides of the first substrate 112 and the second substrate 102 to form a first short side 132 and a second short side 122, and exposing a cross-section of the bonding lead 105; and
step 4 (as S4 shown in the figure), providing a conductive film 206 and a chip-on-film 207 on the cross-section of the bonding lead to form the display panel.

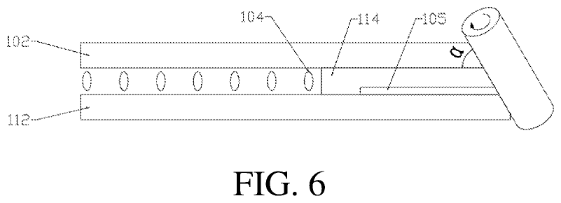

Specifically, shown in FIG. 6 is a schematic diagram of an oblique edge grinding process of one embodiment of the manufacturing method of the present invention. The step 3 further includes: cutting the same sides of the first substrate 112 and the second substrate 102 and then grinding the sides using a grinding wheel to form an oblique edge. An inclination angle of the grinding wheel with respect to the second substrate 102 when grinding the sides is a first angle α, and preferably 1°<α<60°, more preferably 3°<α<50°, and most preferably 5°<α<45°.

The embodiment of the invention adopts the oblique edge grinding method to increase the cross-sectional area of the bonding lead 105 and reduce the contact impedance of the side bonding. Specifically, increase the space for filler 108 coating, increase the dispensing amount of filler, and prevent the problem of filler overflowing caused by small space. In other words, the contact area of the filler 108 to the glass substrate is increased and the adhesion is enhanced; at the same time, the filler 108 forms a projection to secure the glass substrate, so that the frame 109 is more firmly bonded to the glass substrate.

In order to better implement the display panel in the embodiment of the present invention, a display device is further provided, and the display device includes the display panel as described in the above embodiments.

The performance of the display device is further improved by using the display panel described in the above embodiments. In the above-mentioned embodiments, the focus of the descriptions in the various embodiments are different, and the detailed description of the other embodiments is omitted and not described again.

In a specific implementation, each of the above components or structures may be implemented as a separate entity. Any combination can also be implemented as the same or several entities. For the specific implementation of the above various components or structures, please refer to the foregoing method embodiments, and details are not described herein.

For the specific implementation of the foregoing process, please refer to the foregoing embodiments, and details are not described herein again.

The display panel, the manufacturing method thereof, and the display device provided by the embodiments of the present invention are described in detail above. The principles and implementations of the present invention are described herein with specific embodiments. The above description of the embodiments is merely for assisting in understanding the method of the present invention and its core ideas. In the meantime, those skilled in the art may modify the specific embodiments and application scope according to the idea of the present invention, the content of the specification should not be construed as limiting the invention.

1. A display panel, comprising:
a first substrate having a first short side;
a second substrate disposed opposite to the first substrate, the second substrate having a second short side flush with the first short side; and
a chip-on-film bonded to the first short side and the second short side;
wherein the second short side of the second substrate forms a first angle α with a lower surface of the second substrate, and 1°<α<60°.

2. The display panel according to claim 1, wherein the display panel further comprises a bonding lead disposed on a surface of the first substrate adjacent to a side of the second substrate, and the bonding lead extends to the first short side of the first substrate to form a lead cross-section.

3. The display panel according to claim 2, wherein the display panel further comprises a conductive film disposed between the lead cross-section and the chip-on-film.

4. The display panel according to claim 3, wherein the conductive film is made of at least one of metal powder nickel, gold, silver, or tin alloy.

5. The display panel according to claim 1, wherein the display panel further comprises a frame disposed on a side of the first substrate and perpendicular to a lower surface of the first substrate.

6. The display panel according to claim 1, wherein the display panel further comprises a frame disposed on a side of the first substrate, and the frame has an arc shape.

7. The display panel according to claim 1, wherein the display panel further comprises a printed circuit board, and the printed circuit board is bonded to the chip-on-film.

8. The display panel according to claim 5, wherein the display panel further comprises a backlight source fixed to the frame by screws.

9. A method of manufacturing a display panel, comprising:
step 1, providing a first substrate, and disposing a bonding lead on a surface of the first substrate;
step 2, providing a second substrate, and bonding the first substrate to the second substrate;
step 3: performing oblique edge grinding process on same sides of the first substrate and the second substrate to form a first short side and a second short side, and exposing a cross-section of the bonding lead; and
step 4: providing a conductive film and a chip-on-film on the cross-section of the bonding lead to form the display panel.

10. The manufacturing method according to claim 9, wherein the step 3 further comprises:
cutting same sides of the first substrate and the second substrate, and then grinding the sides using a grinding wheel to form an oblique edge.

11. The manufacturing method according to claim 10, wherein an inclination angle of the grinding wheel with respect to the second substrate when grinding the sides is a first angle α, and 1°<α<60°.

12. A display device, comprising a display panel, the display panel comprising:
a first substrate having a first short side;
a second substrate disposed opposite to the first substrate, the second substrate having a second short side flush with the first short side; and
a chip-on-film bonded to the first short side and the second short side;
wherein the second short side of the second substrate forms a first angle α with a lower surface of the second substrate, and 1°<α<60°.

13. The display device according to claim 12, wherein the display panel further comprises a bonding lead disposed on a surface of the first substrate adjacent to a side of the second substrate, and the bonding lead extends to the first short side of the first substrate to form a lead cross-section.

14. The display device according to claim 13, wherein the display panel further comprises a conductive film disposed between the lead cross-section and the chip-on-film.

15. The display device according to claim 14, wherein the conductive film is made of at least one of metal powder nickel, gold, silver, or tin alloy.

16. The display device according to claim 12, wherein the display panel further comprises a frame disposed on a side of the first substrate and perpendicular to a lower surface of the first substrate.

17. The display device according to claim 12, wherein the display panel further comprises a frame disposed on a side of the first substrate, and the frame has an arc shape.

18. The display device according to claim 12, wherein the display panel further comprises a printed circuit board, and the printed circuit board is bonded with the chip-on-film.

19. The display device according to claim 16, wherein the display panel further comprises a backlight source fixed to the frame by screws.
